(19) United States
(12) Patent Application Publication
(10) Pub. No.: US 2017/0354185 A1
(43) Pub. Date: Dec. 14, 2017

(54) PORTABLE VAPORIZATION DEVICE WITH A REMOVABLE CONTAINER

(71) Applicant: Rodrigo Escorcio Santos, Bethesda, MD (US)

(72) Inventor: Rodrigo Escorcio Santos, Bethesda, MD (US)

(21) Appl. No.: 15/618,308

(22) Filed: Jun. 9, 2017

Related U.S. Application Data
(60) Provisional application No. 62/348,385, filed on Jun. 10, 2016.

(51) Int. Cl. A24F 47/00; B65D 25/14; H01M 10/0525

(52) U.S. Cl. CPC A24F 47/008; H01M 10/0525; B65D 25/14; H01M 2220/30

(57) ABSTRACT

A portable vaporization device with a removable container is disclosed. The portable vaporization device includes a heating chamber, a mouthpiece, a battery compartment, and a removable container. The heating chamber is configured to receive and heat an inhalable product to produce vapor. The mouthpiece provides an outlet for the vapor. The battery compartment includes a battery configured to supply energy for heating the inhalable product. The removable container defines a receptacle for storing the inhalable product and the removable container is removably coupleable to a first end of the battery compartment. Meanwhile, the heating chamber is coupled to a second, opposite end of the battery compartment so that the battery compartment extends between the removable container and the heating chamber.

### CROSS-REFERENCE TO RELATED APPLICATIONS

This application claims priority to and the benefit of U.S. Provisional Patent Application No. 62/348,385, filed Jun. 10, 2016, entitled “Portable Vaporization Device,” the contents of which is hereby incorporated by reference in full.

### FIELD OF THE INVENTION

The present invention is directed toward a portable vaporization device, and in particular to a portable vaporization device with a storage container for consumable products that is separated from heating operations of the vaporization device.

### BACKGROUND OF THE INVENTION

In view of developments in technology and the law, vaporization devices have become quite popular. Initially, vaporization devices were quite large and burdensome, but over time, vaporization devices have decreased in size so that the vaporization devices are portable and fit easily into a pocket included in a garment. For example, portable vaporization devices may be shaped and sized like pens. To function, a vaporization device heats a consumable and/or inhalable product such as oils, concentrates, combustible plant substances to create a vapor for a user to inhale. The rate at which vapor is created may vary based on a number of factors, but the rate is mostly controlled by the magnitude of the heat applied to the inhalable substance which is related to the amount of airflow passing through (i.e., entering) a combustion or heating chamber where the inhalable substance is heated.

For example, consumable products may be consumed faster if the combustion or heating chamber includes any escape passages through which created vapor may escape. Unfortunately, most portable vaporization devices allow air and/or vapor to flow through a base of the combustion or heating chamber (i.e., air and/or vapor flows in a direction opposite a mouthpiece of the portably vaporization device. Moreover, typically, portably vaporization devices do not provide a user with any control over the airflow.

Finally, regardless of the rate at which vapor is created, a portable vapor device will eventually need to be refilled with consumable/inhalable products. However, often, portable vaporization devices can only store consumable products in the heating or combustion chamber. Consequently, a user must carry a second case or container to store consumable/inhalable products. In view of the aforementioned issues, an improved portable vaporization device is desired.

### SUMMARY OF THE INVENTION

A portable vaporization device including a removable container is presented herein. According to at least one embodiment, the portable vaporization device includes a heating chamber, a mouthpiece, a battery compartment, and a removable container. The heating chamber is configured to receive and heat an inhalable product to produce vapor. The mouthpiece provides an outlet for the vapor. The battery compartment includes a battery configured to supply energy for heating the inhalable product. The removable container defines a receptacle for storing the inhalable product and the removable container is removably coupleable to a first end of the battery compartment. Meanwhile, the heating chamber is coupled to a second, opposite end of the battery compartment so that the battery compartment extends between the removable container and the heating chamber.

In at least some of these embodiments, the portable vaporization device is a handheld device. Additionally or alternatively, the removable container includes a liner that encapsulates the receptacle when the removable container is removably coupled to the battery compartment. The liner may be a nonstick silicone liner.

In other embodiments, the heating chamber is removably coupleable to the second end of the battery compartment. More specifically, a bottom end of the heating chamber may be removably coupleable to the second end of the battery compartment and a top end of the heating chamber may be coupled the mouthpiece. In at least some of these embodiments, removably coupling the bottom end of the heating chamber to the second end of the battery forms a sealed connection and coupling the top end of the heating chamber to the mouthpiece forms a sealed connection.

In still further embodiments, the heating chamber includes an airflow opening that allows a user to control airflow into the heating chamber. In some instances, except for the mouthpiece, the airflow opening is the only opening that allows air into the heating chamber. Additionally or alternatively, the airflow opening may be sized to be coverable by a human finger. Still further, in some of the embodiments including an airflow opening, the heating chamber includes a heating element disposed adjacent the second end of the battery compartment and the airflow opening extends through a wall of the heating chamber at a location above the heating element.

In still other embodiments, the heating chamber further includes a cylindrical sleeve and a base. The base is disposed adjacent the second end of the battery compartment and the cylindrical sleeve is removably coupleable to the base via silicone gaskets.

According to another embodiment, the present invention is embodied as a removable container for a portable vaporization device. The removable container includes an annular wall, an end wall that extends between the annular wall at an end of the annular wall so that the annular wall and the end wall define a receptacle, and a liner. The liner that encapsulates the receptacle so that the removable container defines a sealed and lined receptacle when attached to the portable vaporization device.

In some embodiments, the annular wall includes a threaded portion configured to form a sealed connection with a corresponding portion of the portable vaporization device. The threaded portion may be concealed when the removable container is forming the sealed connection with the corresponding portion of the portable vaporization device.

Additionally or alternatively, the end of the annular wall is a first end, the annular wall includes a second, opposite end, and the liner includes a receptacle liner and a mating surface liner. The receptacle liner covers a portion of the annular wall and a portion of the end wall that define the receptacle. The mating surface liner covers a surface of the portable vaporization device configured to mate with and extend between the second end of the annular wall. In some instances, the liner is a nonstick silicone liner. The liner may, in addition or as an alternative to being a nonstick silicone liner, thermally isolate the receptacle from heating operations of the portable vaporization device.

According to some embodiments, the aforementioned removable container attaches to a portable vaporization device including a heating chamber, a mouthpiece, and a battery compartment. The heating chamber is configured to receive and heat an inhalable product to produce vapor. The mouthpiece provides an outlet for the vapor. The battery compartment includes a battery configured to supply energy for heating the inhalable product. The removable container is removably coupleable to a first end of the battery compartment and the heating chamber is coupled to a second, opposite end of the battery compartment so that the battery compartment extends between the removable container and the heating chamber.

In at least some embodiments, the receptacle is sized to receive and store a quantity of an inhalable product that is suitable for multiple uses of the portable vaporization device.

### BRIEF DESCRIPTION OF THE DRAWINGS

FIG. 1 illustrates a top view of a portable vaporization device according to an example embodiment of the invention presented herein.

FIG. 2A illustrates an exploded, back perspective view of the portable vaporization device of FIG. 1.

FIG. 2B illustrates an exploded, front perspective view of the portable vaporization device of FIG. 1.

FIG. 3 illustrates an exploded perspective view of a battery and a removable storage container included in the portable vaporization device of FIG. 1.

Like reference numerals have been used to identify like elements throughout this disclosure.

### DETAILED DESCRIPTION

Present herein is a portable vaporization device. The portable vaporization device is a handheld, battery operated, portable vaporization device with a storage container that is suitable for storing consumable and/or inhalable products, such as oils, concentrates, combustible plant substances, and the like, separate from a heating chamber included in the vaporization device. That is, the consumable and/or inhalable products (referred to herein interchangeably as consumable or inhalable products or substances) can be stored in the removable container and selectively moved to the heating chamber so that the consumable and/or inhalable products can be heated to create a vapor (i.e., as a vaporization process acts on the consumable products). Advantageously, the storage container is separated or isolated (spatially and/or thermally) from the heating chamber, but securely connected to the device so that the portable vaporization device can carry inhalable substances outside of its heating or combustion chamber. Moreover, the portable vaporization device includes a sealed heating chamber with an external/accessible airflow opening that allows a user to control a sole source of airflow into the heating chamber (assuming the mouthpiece is sealed, i.e., by a user lips).

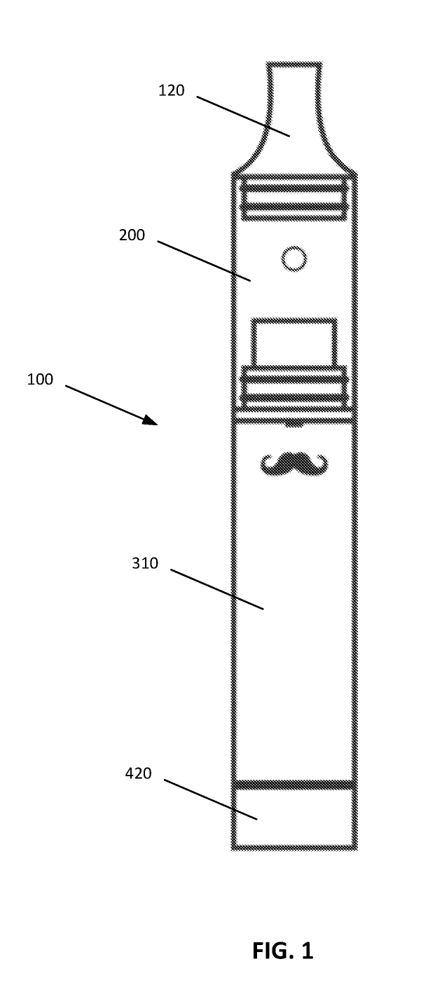

Referring first to FIG. 1, according to at least one example embodiment, a vaporization device 100 of the present invention includes four main parts: a mouthpiece 120, a heating or combustion chamber 200, a battery compartment 310, and a removable container 420. Overall, the portable vaporization device 100 is sized to be held in a user's hand (i.e., the device 100 is handheld). The mouthpiece 120 generally defines a top end of the vaporization device and the removable container 420 generally defines a bottom end of the device 100. The battery compartment 310 and the heating chamber 200 extend between the mouthpiece 120 and the removable container 420 and generally couple the mouthpiece 120 to the removable container 420.

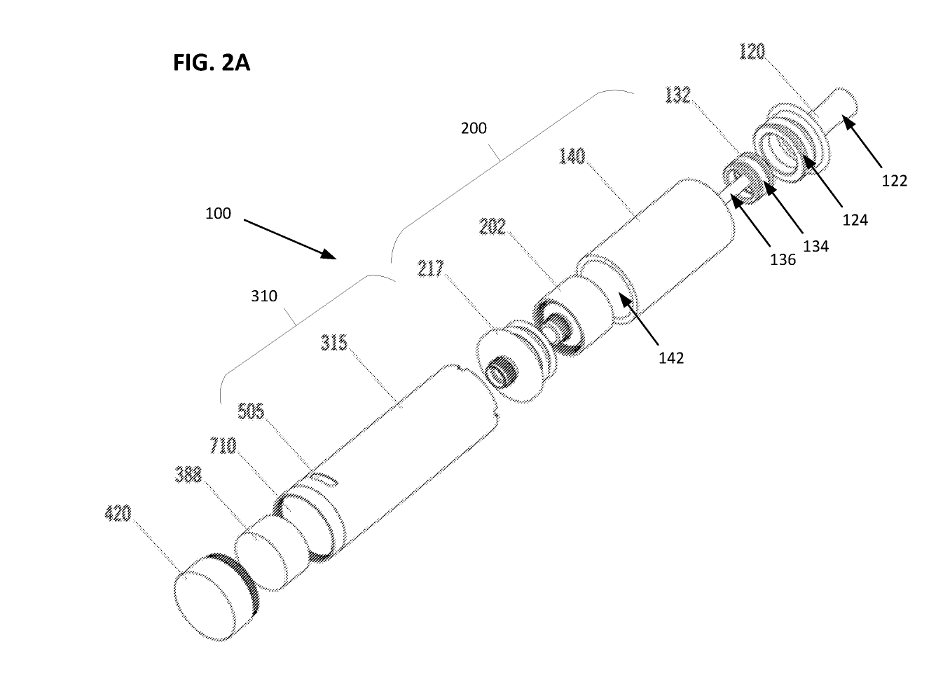

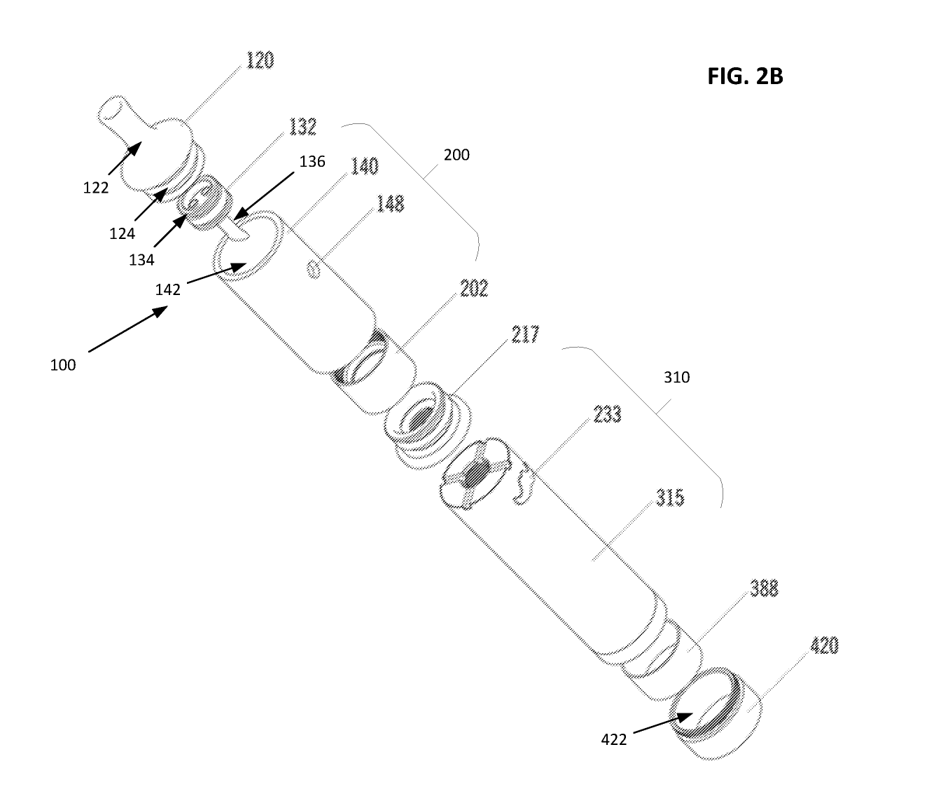

More specifically, a bottom end or side of the mouthpiece 120 is coupled to a top end of the heating chamber 200 (i.e., via rubber or silicone gaskets). Meanwhile, a bottom end or side of the heating chamber 200 is coupled to a top end of the battery compartment 310 while a bottom end of the battery compartment 310 is coupled to the removable container 420. That is, the battery compartment 310 extends between the heating chamber 200 and the removable container 420. In the depicted embodiment, each of these components are removably coupled together via threaded connections and/or rubber-like gaskets (described in further detail below in connection with FIGS. 2A and 2B); however, in other embodiments, these components may be removably coupled together in any manner.

Now referring to FIGS. 2A and 2B, the mouthpiece 120 has an elongate tubular portion 122 and an engagement portion 124. In the depicted embodiment, the elongate tubular portion 122 is substantially cylindrical; however, in other embodiments, the elongate tubular portion 122 may have any shape that defines in an inner opening (i.e., an outlet) that allows vapor or smoke to pass through the mouthpiece 122. That is, the elongate tubular member 122 may be any annular or annular-like shape. The engagement portion 124 is configured to selectively engage the heating chamber 200 to form a sealed connection with the heating chamber 200. More specifically, the engagement portion 124 is or includes external threads and/or one or more rubber gaskets that are configured to engage and/or mate with corresponding sections of a top end of the heating chamber 200. Consequently, the connection between the mouthpiece 120 and the heating chamber 200 may be a sealed connection, insofar as a sealed connection does not allow vapor or air to escape therethrough.

The mouthpiece 120 may also include or be coupleable to a concentrate tool 132. The concentrate tool 132 is configured to be removably secured within the engagement portion 124 of the mouthpiece 120 (i.e., via gaskets and/or threads). More specifically, the concentrate tool 132 may be sized to form a friction or press connection (i.e., friction fit) with an inner wall of the engagement portion 124 (while the outer wall of the engagement portion engages, such as threadably, an inner wall of the heating chamber 200). Regardless of how the concentrate tool 132 is removably coupled to the mouthpiece 120, the concentrate tool will not impact operations of the mouthpiece 120. That is, the concentrate tool 132 will not impede the flow of air through the mouthpiece 120 (or, more specifically, through the tubular portion 122) and will not impact the sealed connection created by an outer wall or surface of the engagement portion 124 of the mouthpiece. The concentrate tool 132 does not impact operations of the mouthpiece 120 at least because the concentrate tool includes a tool head 134 with openings (see FIG. 2B) that allow air to pass therethrough.

The tool head 134 is also sized and configured to transfer inhalable substances from the removable container 420 to the heating chamber 200. For example, the tool head 134 may be inserted into a receptacle 422 of the removable container 420 to gather wax or oil on its surfaces and then the wax or oil may be transferred (i.e., applied) to a heating element 202 included in the heating chamber 200. During these transfer operations, a user can hold the tool 132 by an elongate structure 136 (i.e., a handle or grip). The concentrate tool 132 can be reattached to the mouthpiece 120 after the transferring operations and remain attached (i.e., the concentrate tool may extend into the heating chamber 200) during use of the portable vaporization device 100.

The heating chamber 200 includes a sleeve 140, a base 217, and a heating element 202. The sleeve 140 and the base 217 can house, surround, and/or support the heating element 202 and can collectively form an internal receptacle 142 where consumable and/or inhalable products, such as combustible plants, concentrate, oils, and the like, can be vaporized (i.e., heated to create vapor). Moreover, the base 217 is connected to the sleeve 140 via a sealed connection so that vapor or air cannot pass between the base 217 and the sleeve 140. In the depicted embodiment, this sealed connection is effectuated when external threads and/or one or more rubber (or silicone) gaskets on the base 217 engage and/or mate with corresponding sections of a bottom end of the heating chamber 200. In at least some embodiments, the sleeve 140 is a transparent, or partially transparent, plastic sleeve.

Due, at least in part, to the sealed connection of the sleeve 140 to both the base 217 and the mouthpiece 120, the sleeve 140, mouthpiece 120, and base 217 can collectively form a substantially closed or closeable housing or container for a consumable/inhalable product. In other words, the heating chamber is not supplied with air through its base 217. Instead, the heating chamber 200 includes an airflow opening 148 that a user can modulate (i.e., by selectively covering with their finger) to control airflow into the heating chamber 200. That is, in some instances, except for the mouthpiece 120 (which may be selectively sealed or substantially sealed when a user engages the mouthpiece with their mouth), the airflow opening 148 is the only opening that allows air into the receptacle 142 of the heating chamber 200. Consequently, a user may have complete control over the airflow into the heating chamber 200 (and, thus, the user may be able to control the rate of heating). To facilitate this control, the airflow opening 148 may be sized to be coverable by a human finger.

Since a user can utilize the airflow opening 148 to control how much air reaches the heating element 202, the user can essentially control the amount of vapor produced from heating an inhalable substance with the heating element 202. Consequently, the airflow opening 148 facilitates inhalation of the inhalable vapor produced from an inhalable/consumable product placed in the heating chamber 200. That is, the airflow opening 148 allows the user to create and control the amount of vapor produced by the heating element 202 for inhalation. In at least some embodiment, the airflow opening 148 extends through a wall of the heating chamber 200 (i.e., through a wall of sleeve 140) in a location that is above the heating element 202. That is, the heating element 202 extends a length into the heating chamber 200 and the airflow opening is not aligned with that length. Instead, the airflow opening 148 is disposed above the heating element 202 (as can be seen in FIG. 1) so the airflow opening 148 is not radially aligned (i.e., is radially offset) from the heating element 202. This position allows air to enter the heating chamber 200 and move therein before reaching the heating element 202. This may create a swirl or movement of air in the heating chamber 200 that is beneficial for vaporization processes.

During use, a user can control the amount of air that reaches the heating element 202 by selectively covering the airflow control opening 148. The user can choose to cover the airflow opening 148 to restrict the amount of air reaching the heating element 202, leave the airflow opening 148 open (i.e., uncovered) to allow a maximum amount of air to reach the heating element 202, or a combination of both. By controlling the airflow, the user can determine the amount and type of vapor produced and the temperature of the vapor. Completely covering the airflow opening will result in hotter, denser, but less voluminous vapor. Allowing more air through the airflow control opening will result in a cooler, less dense, more voluminous vapor.

Still referring to FIGS. 2A and 2B, the heating chamber 200 also includes a heating element 202, such as a heating coil. The heating element 202 of the vaporization device 100 is a removable, replaceable heating element made of, for example, 30 gauge kanthal wire wrapped around a quartz filament wick. The heating element 202 serves to heat the inhalable product. For example, the heating element 202 may be built to provide a resistance of 0.80 ohms so that energy transferred into the heating element 202 (i.e., from a battery included in battery compartment 315) causes the heating element to generates heat. The heating element 202 is preferably removable from the heating chamber 200. For example, the heating element 202 may be attached to the tank base 217 via traditional screw threads.

The battery 315 compartment extends between the heating chamber 200 and the removable container 420. The battery compartment 315 may be or include a cylindrical 1100 milliamp hour lithium ion battery or any other battery configured to supply energy for heating the inhalable product. The battery 315 compartment may also include an actuator or power button 233 (i.e., an on/off button 233) and a charging port 505 (i.e., a micro USB charging port) that are configured to interact with and/or control the battery (button 233 is shown in FIG. 2B and charging portion 505 is shown in FIG. 2A). In the depicted embodiment, the battery compartment 315 is connected to the heating chamber 200 via a threaded portion configured to engage and/or mate with a corresponding threaded portion of the base 217. Notably, this threaded connection does not extend through the base 217 and, thus, does not impact the airflow provided to the internal receptacle 142 of the heating chamber 200. At its other end (i.e., its bottom end), the battery compartment 315 is removably connected to the removable container 420 via a sealed, releasable connection. Similar to the sealed connections described above, this sealed connection may be formed with threads and/or rubber-type gaskets (including silicone gaskets). As is described in further detail below, the removable container 420 of the device is a storage compartment, for example, for oils or concentrates not being used in the heating chamber 200.

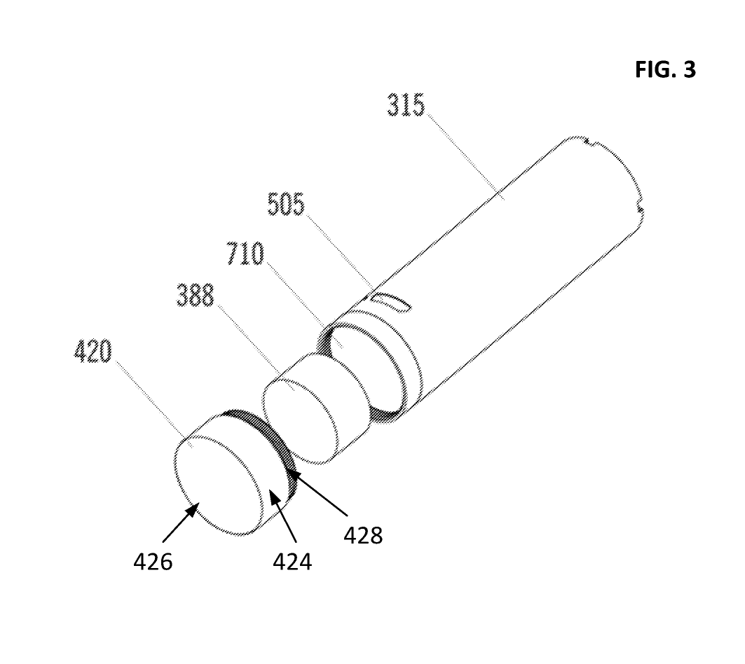

Now referring to FIG. 3, but with continued reference to FIGS. 2A and 2B, in the depicted embodiment, the removable container 420 is formed from an annular wall 424 and an end wall 426. In the depicted embodiment, the annular wall 424 and the end wall 426 are both substantially circular, but in other embodiments, the annular wall 424 and the end wall 426 may be any shape, provided that the end wall 426 extends between the annular wall 424 so that the annular wall 424 and the end wall 426 define a receptacle 422 therein (the receptacle is shown in FIG. 2B). Moreover, in the depicted embodiment, a top end or edge of the annular wall 424 includes a threaded portion 428. The threaded portion 428 is configured to form a sealed connection with corresponding threads included at a lower end of the battery compartment 315. Moreover, the connection is configured to align the annular wall 424 with the outer wall of the battery compartment so that the removable container 420 is substantially flush or aligned with the outer wall of the battery compartment 315. The threaded portion 428 may also be concealed within the battery compartment 315 when the removable container 420 is coupled thereto.

In different embodiments, the annular wall 424 may have different lengths (and/or diameters, widths, etc.) to provide receptacles 422 of different sizes. However, preferably, the receptacle 422 is sized to receive and store a quantity of an inhalable product that is suitable for multiple uses of the portable vaporization device. For example, in some embodiments, the removable container 420 may store approximately two-five grams of oil or wax, which may be suitable for approximately 10 to 100, 10-200, or even 10-500 uses of the portable vaporization device 100.

Additionally, in the depicted embodiment, the removable container 420 includes a liner 388. The liner 388 substantially encapsulates the receptacle 422 so that the removable container 420 defines a sealed and lined receptacle 422 when attached to the portable vaporization device 100 (i.e., when attached to battery compartment 315). More specifically, the liner 388, which may also be referred to as a receptacle liner 388, covers portions of the annular wall 424 and the end wall 426 that define the receptacle 422. Thus, when the container 420 is detached from the device 100, inhalable substances can be placed onto the receptacle liner 388.

When the removable container 420 is attached to the battery compartment 315, a mating face included on a second end of the battery compartment 315 (i.e., the end opposite the heating chamber 200) may close or secure the removable container 420. That is, the mating surface of the battery compartment 315 (or any other part or component of the vaporization device 100 to which the removable container 420 is being connected) may substantially close an end of the annular wall 424 opposite from the end wall 426 and close the receptacle 422. In some embodiments, the liner 388 includes or is configured to engage with a mating surface liner 710 included on the mating surface. Together, the receptacle liner 388 and the mating surface liner 710 (which, for simplicity, may be collectively referred to as a liner) may completely encapsulate the receptacle 422 when the removable container 420 is removably coupled to the portable vaporization device 100. However, the receptacle liner 388 and the mating surface liner 710 need not be coupled together via any connector or connection and, instead, these two liner portions can be pressed together as the removable container 420 is secured to the battery compartment 315 (i.e., via the threads and/or gaskets to provide a sealed connection, as discussed above).

In at least some embodiments, the liner may be nonstick silicone. That is, mating surface line 710 and receptacle liner 388 may each be or include nonstick silicone. Consequently, when the container 420 is secured to the battery compartment 315 (via a sealed connection), a nonstick silicone liner may encapsulate any consumable products stored in a receptacle 422 defined by the container 420. This may prevent any consumable products from sticking or adhering to the container 420 and, moreover, in at least some embodiments, this encapsulation may insulate consumable products stored within container 420 from any heat generated by heating operations of the portable vaporization device 100. This insulation may supplement or replace the natural insulation provided afforded to the removable container 420 due to its location with respect to the heating chamber. That is, at least because the removable container 420 is spaced apart from the heating chamber 200 by the length of the battery chamber 315, the removable container may at least partially thermally isolated from the heat of the heating chamber 200 (or more specifically, the heat of heating element 202). However, in other embodiments, the battery chamber 315 need not provide the physical separation and the physical separation may be created with any part of component of the portable vaporization device 100.

Now referring generally to the Figures, in use, device 100 heat oils, concentrates, combustible plant substances, and the like on or with the heating element 202 to produce vapor for inhalation. More specifically, in use, a user places a small amount of the desired substance directly onto the heating element (coil) 202. For example, some of the substance (i.e., wax or oil) stored in the removable container 420 may be transferred (i.e., with the concentrate tool 132) from the receptacle 422 to the heating element 202. Then, the heating element 202 utilizes energy from a battery included in battery compartment 315 (i.e., a lithium ion battery) to generate heat and vaporize the substance. As the consumable/inhalable product is heated, inhalable vapor fills the receptacle 142 formed, at least in part, by the sleeve 140. Then, the user can inhale the vapor, which is suitable for human inhalation and can serve purposes such as stimulation of mood, lessening of anxiety, via mouthpiece 120, at his or her convenience. During vapor production and/or inhalation, the user can modulate the heating of the consumable/inhalable product by selectively covering airflow opening 148.

As a more specific example, a user may first charge the battery included in battery compartment 315 via the charging port 505 located on the front of the battery compartment 315. Once the device is sufficiently charged, the user may power on the device rapidly (i.e., by pressing the on/off button 233 five times within two seconds to power the device ‘on’). The on/off button may flash to indicate that the device is ‘on.’ Then, the user would place a small amount of the desired substance (concentrate, oil, etc.) directly onto the coil heating element 202. The user can then assemble any dissembled parts of device 100 (i.e., by screwing the heating element 202 onto the tank base 217, threading the tank base 217 to the battery 315 portion, and/or securing gaskets of the plastic tank sleeve 140 over the heating element 202 and onto the tank base 217 to secure the sleeve 140 and mouthpiece 120 to the remaining components of device 100). To vaporize the substance, the user may depress and hold the on/off button 233 while inhaling through the mouthpiece 120. Depressing and holding the on/off button 233 supplies energy to the heating element 202, heating the heating element 202 and, in turn, the desired substance. Once the substance reaches its unique vaporization temperature, the solid or liquid substance is converted into an inhalable vapor that the user can consume.

When the user is finished with the device 100, any additional oil, concentrate or other such consumable/inhalable product can be stored in the removable, silicone lined container 420, and the container 420 can be attached to the bottom of the device 100. The device can also be powered off (i.e., by again depressing the on/off button 233 quickly five times within two seconds).

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. For example, the battery compartment 315 is not the only component that can extend between the removable container 420 and the heating chamber 200 to separate these two components and, in other embodiments, any component of device 100 may separate the removable container 420 and the heating chamber 200. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the portable vaporization device of the present invention, or portions thereof, may be fabricated from any suitable material or combination of materials, provided that the device, or portions thereof, can function as described herein (i.e., withstand heating forces and form sealed connection). Example materials include plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

What is claimed is:

1. A portable vaporization device comprising:
a heating chamber configured to receive and heat an inhalable product to produce vapor;
a mouthpiece providing an outlet for the vapor;
a battery compartment including a battery configured to supply energy for heating the inhalable product; and
a removable container that defines a receptacle for storing the inhalable product, wherein the removable container is removably coupleable to a first end of the battery compartment and the heating chamber is coupled to a second, opposite end of the battery compartment so that the battery compartment extends between the removable container and the heating chamber.

2. The portable vaporization device of claim 1, wherein the portable vaporization device is a handheld device.

3. The portable vaporization device of claim 1, wherein the removable container further comprises:
a liner that encapsulates the receptacle when the removable container is removably coupled to the battery compartment.

4. The portable vaporization device of claim 3, wherein the liner is a nonstick silicone liner.

5. The portable vaporization device of claim 1, wherein the heating chamber is removably coupleable to the second end of the battery compartment.

6. The portable vaporization device of claim 5, wherein a bottom end of the heating chamber is removably coupleable to the second end of the battery compartment and a top end of the heating chamber is coupled the mouthpiece.

7. The portable vaporization device of claim 6, wherein removably coupling the bottom end of the heating chamber to the second end of the battery forms a sealed connection and coupling the top end of the heating chamber to the mouthpiece forms a sealed connection.

8. The portable vaporization device of claim 1, wherein the heating chamber further comprises:
an airflow opening that allows a user to control airflow into the heating chamber.

9. The portable vaporization device of claim 8, wherein, except for the mouthpiece, the airflow opening is the only opening that allows air into the heating chamber.

10. The portable vaporization device of claim 8, wherein the airflow opening is sized to be coverable by a human finger.

11. The portable vaporization device of claim 8, wherein the heating chamber comprises:
a heating element disposed adjacent the second end of the battery compartment and the airflow opening extends through a wall of the heating chamber at a location above the heating element.

12. The portable vaporization device of claim 1, wherein the heating chamber further comprises:
a cylindrical sleeve; and
a base, wherein the base is disposed adjacent the second end of the battery compartment and the cylindrical sleeve is removably coupleable to the base via silicone gaskets.

13. A removable container for a portable vaporization device comprising:
an annular wall;
a end wall that extends between the annular wall at an end of the annular wall so that the annular wall and the end wall define a receptacle; and
a liner that encapsulates the receptacle so that the removable container defines a sealed and lined receptacle when attached to the portable vaporization device.

14. The removable container of claim 13, wherein the annular wall comprises:
a threaded portion configured to form a sealed connection with a corresponding portion of the portable vaporization device.

15. The removable container of claim 14, wherein the threaded portion is concealed when the removable container is forming the sealed connection with the corresponding portion of the portable vaporization device.

16. The removable container of claim 13, wherein the end of the annular wall is a first end, the annular wall includes a second, opposite end, and the liner comprises:
a receptacle liner that covers a portion of the annular wall and a portion of the end wall that define the receptacle; and
a mating surface liner that covers a surface of the portable vaporization device configured to mate with and extend between the second end of the annular wall.

17. The removable container of claim 16, wherein the liner is a nonstick silicone liner.

18. The removable container of claim 16, wherein the liner thermally isolates the receptacle from heating operations of the portable vaporization device.

19. The removable container of claim 13, wherein the portable vaporization device comprises:
a heating chamber configured to receive and heat an inhalable product to produce vapor;
a mouthpiece providing an outlet for the vapor; and
a battery compartment including a battery configured to supply energy for heating the inhalable product, wherein the removable container is removably coupleable to a first end of the battery compartment and the heating chamber is coupled to a second, opposite end of the battery compartment so that the battery compartment extends between the removable container and the heating chamber.

20. The removable container of claim 13, wherein the receptacle is sized to receive and store a quantity of an inhalable product that is suitable for multiple uses of the portable vaporization device.
